(19) United States
(12) Patent Application Publication
(10) Pub. No.: US 2013/0276012 A1
(43) Pub. Date: Oct. 17, 2013

(54) Method, Apparatus and Computer Program for Triggering an Event

(71) Applicant: 2ND SCREEN LIMITED, London (GB)

(72) Inventor: Simon Dominic Ingram, London (GB)

(73) Assignee: 2nd Screen Limited, London (GB)

(21) Appl. No.: 13/858,339

(22) Filed: Apr. 8, 2013

Related U.S. Application Data
(60) Provisional application No. 61/622,985, filed on Apr. 11, 2012.

(51) Int. Cl. H04N 21/442

(52) U.S. Cl. CPC H04N 21/442
USPC 725/18

(57) ABSTRACT

An event is associated with content being broadcast over a medium and being played back on a user playback device. At least one of an audio component and a video component of content that is being played back on the user playback device is received at a second user device. The received audio component and/or video component is compared with comparison data that is stored on or otherwise locally accessible to the second user device. When the received audio component and/or video component contains an element that, in accordance with the comparison, is determined to correspond to an audio cue or a visual cue respectively that is transmitted with the content, an event is caused to be triggered by the second user device.

### CROSS REFERENCE TO RELATED APPLICATION

This application claims priority to U.S. Patent Application Ser. No. 61/622,985, filed on Apr. 11, 2012, the content of which is incorporated herein by reference in its entirety.

### TECHNICAL FIELD

The present invention relates to a method, apparatus and computer program for triggering an event that is associated with content being broadcast over a medium and being played back on a user playback device, the event being triggered by a second user device.

### BACKGROUND

Systems for allowing viewers of broadcast television programmes to interact somehow with the programme are becoming increasingly popular. Examples include quiz shows where viewers enter their own answers to questions posed during airing of the programme, talent shows where viewers can vote for their favorite artist or act or the like, product purchase or gambling shows, etc.

Many such systems cause some overlay to be presented on the screen of the device that the viewer is using to watch the show, which is often the screen of a household's main television receiver, but may be the screen of a laptop or fixed computer, etc. However, this overlay can spoil or otherwise disrupt the image of the show that is being displayed on the screen, which may spoil the experience of the viewer. This is particularly the case where several people are viewing the show on the same screen, but only one or some of them is interested in the overlay. For example, a quiz show may be being broadcast where viewers can if they wish enter their own answers to questions being posed. Some members of a family watching the show may be interested in participating and giving their own answers, but others may simply wish to view the show without the picture image being disrupted.

Moreover, many systems suffer from synchronization problems, for a number of reasons. Satellite, terrestrial, cable and Internet transmissions all have a latency from transmission by the broadcaster to receipt and display at a user device, which varies according to location, type and model of set top box used, etc., even within the same broadcast mechanism for different users as well as between these different transmission systems. For programmes or play-along applications broadcast or triggered over the Internet in particular, the Internet is of course not real time: data is sent in packets that can be routed different ways even though intended to be reassembled at the user's device to form single content for display, etc. In a particular example, this means that the viewer watching a TV show on their television and playing along using an application running on their laptop and triggered over the Internet does not get a truly synchronized experience, even if a synchronized trigger is sent at the point of broadcast. It also means it is difficult if not impossible to fairly run competitions where time is used to judge success (for example, the winners are the ten people who answered correctly in the quickest time (to within x milliseconds based on testing and verification)).

A number of proposals have been made for dealing with these synchronization problems. For example, US-A1-2004/0244057 discloses a system for synchronization of behavior and operation among a group of receivers in a broadcast environment. Event data, including timing data associated with events referenced against a reference time, is stored in a user's set-top box or the like in advance of broadcast of the relevant television show. This event data, alone or in conjunction with additional transmitted triggering data, is compared to a reference timing signal. This combination of data is then used to control the local execution of an application on each set-top box. However, such applications are time-consuming to write and costly to build and test, and will only run on the set-top box for which they were written. Moreover, this system still produces an overlay on the screen on which the show is being viewed and all data is stored in and comparisons made on the same set-top box that is being used to receive and decode the broadcast content for viewing on the user's television.

Many people these days have a “smart phone”, or PDA (personal digital assistant) or tablet device or the like. In general terms, these can often be regarded as small, relatively low power computers with their own small screens and are highly portable as they are so small and lightweight. Significantly, they are often connected to some network (whether the Internet or some mobile telephone/data network for example) over which data can be received, typically wirelessly, and moreover, are often “personal” to the user in that often they are used solely by one person at a time.

Media-Sync, a product of a joint venture between The Nielsen Company and Digimarc Corporation, uses “audio watermarks”. These are acoustically masked audio data packets that are embedded into television broadcasts and overlaid onto a program's audio in such a way that they are imperceptible to the human ear but can be picked up by microphones and decoded on smart phones and tablets. The watermark payloads contain codes that identify the content's source distributor/network as well as a date/time stamp. Using Electronic Programming Guide (EPG) data, the Media-Sync platform can resolve what episode is being watched and the position in the show to the second. This allows content modules based on a show's timeline to be triggered. However, this system requires that the user's smart phone or tablet, etc. be connected to central servers at all times, both to resolve what is contained in any detected audio watermarks and also to receive content modules that are to be delivered. This in itself brings about a number of problems, including scalability of the system with the number of users and synchronization between users.

### SUMMARY

In a first exemplary embodiment of the invention, there is a method of triggering an event, the event being associated with content being broadcast over a medium and being played back on a user playback device, the method comprising: receiving, at a second user device, at least one of an audio component and a video component of content that is being played back on a user playback device; comparing the received audio component and/or video component with comparison data that is stored on or otherwise locally accessible to the second user device; and, when the received audio component and/or video component contains an element that, in accordance with the comparison, is determined to correspond to an audio cue or a visual cue respectively that is transmitted with the content, causing an event to be triggered by the second user device.

In a second exemplary embodiment of the invention, there is a user device for triggering an event, the event being associated with content being broadcast over a medium and being played back on a user playback device, the user device comprising: a receiver for receiving at least one of an audio component and a video component of content that is being played back on a user playback device; and, a processing system arranged to compare the received audio component and/or video component with comparison data that is stored on or otherwise locally accessible to the user device, and arranged to cause an event to be triggered when the received audio component and/or video component contains an element that, in accordance with the comparison, is determined to correspond to an audio cue or a visual cue respectively that is transmitted with the content.

In a third exemplary embodiment of the invention, there is a method of triggering an event, the event being associated with content being broadcast over a medium and being played back on a user playback device, the method comprising: transmitting comparison data and event data relating to content that is to be subsequently broadcast for play back on a user playback device, the comparison data and the event data being for storage at or locally to a second user device; subsequently broadcasting said content for play back on a user playback device; and, receiving a result of a user input to a said second user device that is given in response to an event being triggered by the second user device that indicates that user input is required, the event being triggered at a said second user device by the event data following a comparison of at least one of an audio component and video component of the content being played back on a said user playback device and received at a said second user device with the comparison data that is stored on or otherwise locally accessible to a said second user device wherein the comparison is determined to correspond to an audio cue or a visual cue respectively that is transmitted with the content.

In a fourth exemplary embodiment of the invention, there is apparatus for triggering an event, the event being associated with content being broadcast over a medium and being played back on a user playback device, the apparatus comprising: a transmission system arranged to transmit comparison data and event data relating to content that is to be subsequently broadcast for play back on a user playback device, the comparison data and the event data being for storage at or locally to a second user device; a broadcast system arranged to subsequently broadcast said content for play back on a user playback device; and, a receiver for receiving a result of a user input to a said second user device that is given in response to an event being triggered by the second user device that indicates that user input is required, the event being triggered at a said second user device by the event data following a comparison of at least one of an audio component and video component of the content being played back on a said user playback device and received at a said second user device with the comparison data that is stored on or otherwise locally accessible to a said second user device wherein the comparison is determined to correspond to an audio cue or a visual cue respectively that is transmitted with the content.

In a fifth exemplary embodiment of the invention, there is a non-transitory computer-readable storage medium comprising code stored thereon such that when the code is executed on a user device, the user device is arranged to: receive at least one of an audio component and a video component of content that is being played back on a user playback device; compare the received audio component and/or video component with comparison data that is stored on or otherwise locally accessible to the user device; and, when the received audio component and/or video component contains an element that, in accordance with the comparison, is determined to correspond to an audio cue or a visual cue respectively that is transmitted with the content, cause an event to be triggered by the second user device.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an overview of an example of a user device interacting with a broadcast programme and obtaining a program and data therefor in accordance with an embodiment of the present invention;

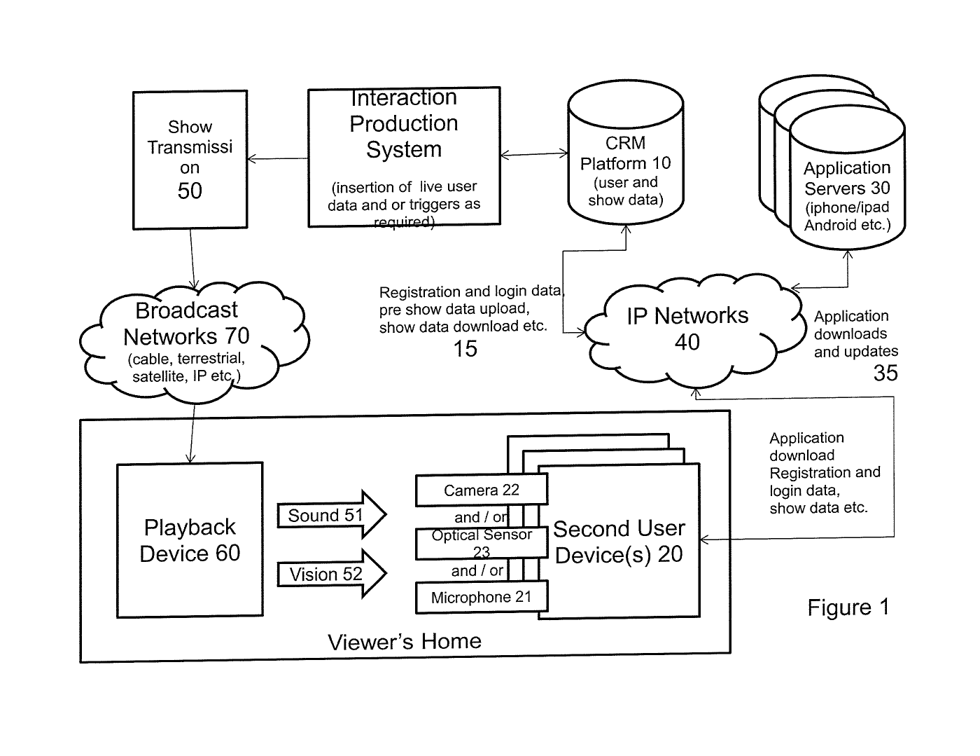

FIG. 2 shows schematically an example of the overall process concerning a show or other programme that is pre-recorded in accordance with an embodiment of the present invention; and,

FIG. 3 shows schematically an example of the overall process concerning a show or other programme that is broadcast live in accordance with an embodiment of the present invention.

### DETAILED DESCRIPTION

The user playback device in a typical application of an exemplary embodiment is a household's main television receiver, or screen of a laptop or fixed computer, which can typically be viewed by several people at once. While television viewing is the main area of interest, this invention can also be applied in the context of radio or other audio-only shows. Because the second user device is used to trigger the event, the experience of others viewing or otherwise enjoying the playback of the content on the user playback device is not disrupted, and the event can be properly synchronized locally with the broadcast content. Only the one or more persons actually interested in interacting with the broadcast content need use a second device as described. This also allows several people to interact with the transmitted content independently and simultaneously using their own respective second user devices while all experiencing playback of content on the same user playback device. The second user device will typically be of the highly portable type, such as a smart phone, or PDA or tablet device or the like, though may in general terms be any suitable computing device, including for example laptops and fixed computers.

Because the comparing is carried out locally (typically on the second user device in one embodiment), using comparison data that is stored on or otherwise locally accessible to the second user device (in one embodiment, typically on the second user device itself or on some local storage device to which the second user device is connected), it is not necessary for the second user device to be connected to any network during transmission and play back of the content. This greatly improves the scalability of the system and also overcomes many problems associated with latency, as discussed further below.

In one exemplary embodiment, the second user device does not have to decode any broadcast transmission. In this context, it merely needs to be able to receive the audio component and/or video component being played back on the user playback device, for example via an integral or attached microphone or camera respectively.

In an exemplary embodiment, the triggered event comprises the second user device outputting a prompt for the user. The prompt may for example be display of a predetermined image on a display screen to which the second user device outputs a video signal. The image is typically related to the interaction required of the user, such as display of a message indicating that some user input is required, or providing information relevant to the content being played back or of details of other users experiencing the same content. By displaying the predetermined image on the display screen to which the second user device outputs a video signal, rather than on a display screen associated with the user playback device for example, the viewing experience of other viewers of the content displayed on the user playback device is not affected. It will be understood that the display screen to which the second user device outputs a video signal will often be a display screen of the second user device itself, but may be for example a larger display screen or monitor to which the second user device is connected. In addition or alternatively to displaying an image, the second user device may output an audio signal (via for example an internal or external loudspeaker or connected headphones) for the user, which again may indicate that some user input is required for example.

As yet further examples, the triggered event may be display or playback of video and/or audio content on the second user device. This may include for example information relating to the show being broadcast, content from advertisers or sponsors, etc., such information or content being downloaded to the second user device prior to the show being broadcast, or possibly being obtained in some cases “on-the-fly” during broadcast of the show if the second user device has a suitable connection for receiving such information or content during transmission. The triggered event may be activation of other features on the second user device, such as activation of other applications or features, such as automatically telephoning the broadcaster or content provider (or some third party) to allow the user to participate quickly in a “phone-in” competition or chat show or the like.

In an exemplary embodiment, the triggered event comprises starting a timer that is based on a clock associated with the second user device. This provides a simple synchronization for triggering of the events and optionally for recording the timing of user interactions using the second user device. It accommodates different latencies that may apply to different viewers who use different systems to receive the broadcast content (e.g. satellite, terrestrial, cable and Internet).

In an exemplary embodiment, the triggered event comprises initiation of a procedure that permits user input to the second user device. The user input may relate to voting in a talent show, entering answers for a quiz show, gambling, purchase of products, etc., etc.

In an exemplary embodiment, the method comprises transmitting the results of user input. The results in one embodiment are transmitted at the end of the show relating to the transmitted content, which avoids problems arising when many user devices are all attempting to transmit results practically simultaneously to a single recipient, though in another embodiment the results may be transmitted at certain key points during broadcast of the show.

In an exemplary embodiment, the triggered event comprises starting a timer that is based on a clock associated with the second user device and outputting, a predetermined time after the timer has started, a prompt to the user indicating that user input is required; and comprising: receiving a user input at the second user device and recording the elapsed time from when the prompt was output to when the user input was received; and, transmitting data corresponding to the user input and the elapsed time.

The elapsed time is preferably recorded in a secure manner, for example using suitable encryption, and stored locally to the second user device. The data corresponding to the user input and the elapsed time can then be transmitted later at a convenient time, when the second user device is connected to a network and for example at the end of the show relating to the transmitted content.

In an exemplary embodiment, said data corresponding to the user input and the elapsed time is transmitted to at least one of a provider of the content and a broadcaster of the content.

In an exemplary embodiment, the method comprises, prior to the content being transmitted, receiving comparison data for use in the comparison and storing said comparison data at or locally to the second user device. The comparison data can be pre-loaded at or locally to the second user device, prior to transmission of the content that is to be played back on the user playback device. Similarly, software applications and/or data relating to the event to be triggered can also be downloaded and pre-loaded at or locally to the second user device, prior to transmission of the content. This avoids having to have a network connection between the second user device and some broadcaster or content provider during transmission and play back of the content, again improving the scalability of the system and also overcoming many problems associated with latency, as discussed further below.

In an exemplary embodiment, the processing system described above is arranged to cause an event to be triggered that comprises outputting a prompt for the user.

In an exemplary embodiment, the processing system described above is arranged to cause an event to be triggered that comprises starting a timer that is based on a clock associated with the user device.

In an exemplary embodiment, the processing system described above is arranged to cause an event to be triggered that comprises initiation of a procedure that permits user input to the user device.

In an exemplary embodiment, the processing system described above is arranged to cause transmission of the results of user input.

In an exemplary embodiment, the processing system described above is arranged to cause an event to be triggered that comprises starting a timer that is based on a clock associated with the user device, and outputting, a predetermined time after the timer has started, a prompt to the user indicating that user input is required, the user device having an input device arranged to receive a user input, the processing system being arranged to record the elapsed time from when the prompt was output to when the user input was received and to cause transmission of data corresponding to the user input and the elapsed time.

In an exemplary embodiment, the processing system described above is arranged to cause transmission of said data corresponding to the user input and the elapsed time to at least one of a provider of the content and a broadcaster of the content.

In an exemplary embodiment, the processing system described above comprises at least one processor and at least one memory including computer program code, the at least one memory and the computer program code being configured to, with the at least one processor, cause the apparatus at least to perform as described above.

Referring now to the drawings, in a particular exemplary embodiment, a user wishing to interact (in some way as discussed further below) with a broadcast programme initially registers with a server 10 operated by a provider of data and/or software that will be required to interact with the programme. For this registration process, the user will use his/her own user device 20, which will typically be of the highly portable type, such as a smart phone, or PDA or tablet device or the like, though may in general terms be any suitable computing device, including for example laptops and fixed computers, and which may connect via one or both of a wired connection and a wireless connection to a network, including the internet. On registration, optionally using some user name and password and also optionally requiring payment of some fee, data 15 relevant to the programme is transmitted to the user device 20 to be stored locally to the user device 20. The data 15 is preferably sent in encrypted form to prevent or deter users tampering with the data 15, and is sent over the Internet or some other network (such as a mobile telephone network) 40 to which the user device 20 has access. Typically, the data 15 will be stored on a storage device of the user device 20, but may alternatively or additionally be stored on some other storage device to which the user device 20 can connect, such as a network-attached storage (NAS) system that the user may have running. The provider of the data 15 may be the broadcaster of the programme, or the content provider of the programme content, or some third party, any of which is effectively operating some customer relationship management platform on the server 10.

An appropriate computer program runs on the user device 20. This program (often colloquially referred to at present as an “app”) may be one that was obtained previously by the user, for example as a download 35 from some application server 30 over the Internet or some other data network 40 to which the user device 20 connects, or may be provided as part of the download obtained on the registration mentioned above, or a combination of these two. This program is started by the user preferably before or around the time that broadcast of the programme begins. The program may require the user to input or select details of the broadcast programme being viewed or about to be viewed so that the program can call on the correct stored data when running. As an alternative, the program may detect the broadcast programme 50 as it is being played back at the user's home.

A key feature of the program running on the user device 20 is that it causes the user device 20 to monitor the broadcast programme 50 and to capture at least one of audio and video from the broadcast programme 50 as it is received and played back on a user playback device 60. The user playback device 60 will typically be a main or secondary television receiver of a household, though may be for example a laptop or other computer or any other device that is able to play back broadcast material. Such a device 60 may have integral loudspeakers or may be connected to external loudspeakers for example. Such a device 60 may similarly have an integral display screen or may be connected to an external (larger) display screen for example. The programme 50 may be broadcast over any suitable medium 70 using any suitable technology, such as satellite, terrestrial, cable and the Internet.

In general, in the following, it is assumed that the broadcast programme 50 is a television show, which has audio and video components 51,52, and that the user device 20 monitors only the played back audio 52 (using a microphone 21 that is integral with or connected to the user device 20). However, the user device 20 may alternatively or additionally monitor played back video (using a video camera 22 that is integral with or connected to the user device 20) in a corresponding manner. Alternatively or additionally, the user device 20 may have or be connected to an optical sensor 23, such as a photoelectric diode device, which may be positioned over the screen of the user playback device 60 at a specific position so as to be able to receive specific video cues transmitted with the broadcast programme 50.

As the broadcast programme 50 is played back on the user playback device 60, the audio is received at the user device 20 (via a microphone 21 that is integral with or connected to the user device 20). The received audio is compared on the user device 20 with comparison data that is part of the data previously downloaded by the user on registration discussed above. That comparison data contains audio “triggers” such that when the received audio contains a portion that is determined to correspond to a cue that is transmitted as part of the content of the broadcast programme, the program running on the user device 20 causes an event to be triggered by the second user device 20. Use may be made here of an “acoustic fingerprint” of the received audio, which is a condensed digital summary, deterministically generated from the audio signal, and which may be compared with the audio triggers previously downloaded to the user device 20. The acoustic fingerprints may be based on spectrogram data representing time, frequency, and intensity for example and can easily be compared with appropriate audio triggers. In one embodiment, the program running on the user device 20 may detect the broadcast programme as it is being played back on the user playback device 60, for example on “hearing” the opening theme tune or some other similar cue for the broadcast programme, which saves the user having to enter or select the broadcast programme details as part of the registration process mentioned above.

The cues, which are transmitted as part of the content of the broadcast programme and to which the audio triggers correspond, may be of different types, even within the same broadcast programme. For example, for pre-recorded shows, it is possible to insert specific audio cues into the broadcast content. Such inserted cues may be audible to the human ear, or may be inaudible to the human ear but nevertheless will be played back by the user playback device 60 and detected by the microphone of the user device 20. For live shows, an operator associated with the broadcaster can insert audio cues “on the fly” during transmission at appropriate points. Alternatively or additionally, audio cues may correspond to certain theme tunes, or catch phrases or “stings” of a show, such as a particular short piece of music, drum roll or the like that always precedes a particular point in the show (such as when contestants should answer a question or make a vote), or indeed any audio (or, more generally, any audio and/or video) that is uniquely identifiable by the program running on the user device 20.

When it is determined by the program running on the user device 20 that an audio cue has been detected, as mentioned, an event is triggered by the program running on the second user device 20. This event may take many forms and relate to many different things. It may relate to display on the screen of the user device 20 of graphics, and/or play back of audio, relating to content or advertising, etc., that is relevant to the broadcast programme. It may relate to display on the screen of the user device 20 of an image and/or playback of audio that indicates that some user input is required and, furthermore, initiate a process by which the user device 20 is put in a state where it can accept a user input. (Such user input may take any suitable form, such as an audio input or more simply presses on a keypad or touch screen or the like.) As another example, the event may relate to display on the screen of the user device 20 of questions that are being posed in a quiz show being played back on the user playback device 60, optionally initiating a process by which the user device 20 displays or plays back video or audio prompts for the user to input answers to the user device 20 and the user device 20 is set to receive such answers as inputs. As yet another example, the event may relate to display on the screen of the user device 20 of information relating to other users who are watching the same broadcast material. This is of course likely to be subject to certain privacy restrictions, such as an “opt-in” arrangement such that users must indicate their willingness to have others know what they are watching, and/or may be based on some “friends” arrangement whereby other users who are registered as “friends” of each other have their information shared in this manner. Nevertheless, there is currently much interest from many consumers for some mechanism to know what friends or family are currently watching so that they can then “chat” with each other (using online chat arrangements such as Instant Messaging or the like) during transmission of the programmes.

One option for the event is to start a timer based on a clock that is local to the user device 20 (such as a clock running on the user device 20, for example as part of a main processor of the user device 20). Significantly, this achieves synchronization for all registered users who are using their user devices 20 during playback of the broadcast programme 50 (on the same or different user playback devices 60). This is because the timer of each user device 20 is triggered by reception of a specific broadcast audio/video cue as it is played back by the users' playback device 60 and received at the user device 20. Subject to very minor timing differences owing to different processor speeds, etc. at the user devices 20, this means that all user inputs are effectively synchronized from when those individual users were prompted by reception of the broadcast programme, irrespective of different latencies in reception of the broadcast programme 50 owing to the use of a different medium 70 to receive the broadcast programme 50 (such as satellite, terrestrial, cable and the Internet). Indeed, the broadcast programme 50 may contain hidden cues, such as audio cues, that indicate the medium 70 (such as satellite, terrestrial, cable and the Internet, etc.) over which the broadcast programme 50 is being transmitted and therefore received at the user playback device 60. This allows timing to be tailored according to the medium 70. It also allows different events to be triggered, for example different questions for users or different content to be displayed on the second user device 20, depending on the medium 70 used for reception of the broadcast programme by the different users.

This timer can be used to record the time taken from a prompt being given to a user (such as by display on the user device 20) to an input being received from the user. This is useful in competitions such as quiz or gambling shows for example, where the first or first of a limited number of users who make an appropriate response are judged to be “winners”, or in online purchase shows where a limited number of products is available on a “first come, first served” basis, etc. It also allows time windows to be closed after a certain period of time has elapsed, so that users can only provide an input within a predetermined period of time. This is useful say in a talent show, where users must vote within a fixed period of time, after which votes cannot be entered.

When a user input to their user device 20 is required, the results of that user input, optionally with timing data representing the time elapsed from when the user was prompted to when the user entered the input, can be transmitted to the broadcaster or content provider or some third party responsible for managing responses. This user input and timing data is preferably sent in encrypted form to avoid tampering and is typically sent over the Internet or other data network 40 to which the user device 20 connects and via which the data 15 relevant to the programme was obtained.

It should be noted that the user device 20 does not have to decode anything that is broadcast with or for the programme 50, which is intended for the user playback device 60. As such, the user device 20 does not have to have television or radio receiver circuitry for example.

Importantly, the comparison of the audio stream of the broadcast programme 50 being played back on the user playback device 60 with the comparison data stored locally to the user device 20 is carried out locally on the second user device 20, using the comparison data 15 which is preloaded from some central server 10. It is not necessary for the user device 20 to be connected to any central server or other data provider during playback of the broadcast programme 50. This contrasts with a number of prior art arrangements where the user device (which in the prior art may be the user playback device or some second device as in the present embodiments) has to be connected by a network to a central server to receive and send data contemporaneously with the user watching the broadcast programme, for example to receive advertising content or information relevant to the broadcast programme and to transmit votes or other inputs from the user to the broadcaster or content provider. Such prior art arrangements can have serious problems given the different latencies inherent to different transmission systems as discussed above. Moreover, these prior art arrangements have scalability problems in that while they may be effective for a relatively small number of users (of the order of a few hundred say), such systems can be swamped when the number of users rises to thousands or even millions. It is a fact that some talent shows say are viewed by many millions of people in any country and major networking problems relating to congestion and delay can arise if a very large number of users attempt to interact with a central server (for example by voting) practically simultaneously. In the preferred embodiments of the present invention, the comparison data can be preloaded from some central server in principle at any time prior to transmission of the broadcast programme, which in itself minimizes congestion. In the preferred embodiments of the present invention, the comparison of the audio stream of the broadcast programme 50 with the comparison data 15 is carried out locally on the second user device 20, which avoids all users attempting to transmit data relating to the broadcast programme 50 simultaneously to some broadcaster or content provider, etc. Moreover, when for example a user input to their user device 20 is required, the results of that user input, optionally with timing data representing the time elapsed from when the user was prompted to when the user entered the input, can be transmitted later, after the broadcast programme 50 has finished say. This can be controlled by the software running on each user device 20 so as to control the timing of return of data from the user devices 20 in a staged way, over time, to avoid or minimize congestion.

In short, in the preferred embodiments, a connection to receive data and to transmit data need only be made prior to and after a particular broadcast programme is being aired. All sampling and comparison activities, as well as receiving and recording user input, optionally with timing, can be carried out offline. A connection of the user device 20 during transmission of the particular broadcast programme is not required (though optionally in some embodiments a connection may be made at one or more key points during broadcast of the programme in order for data to be uploaded from the second user device 20 during the broadcast).

In addition, in the preferred embodiments, all of the processes at the user-end can be carried out on the user device 20 and do not have any impact on what is being played back on the user playback device 60. For example, no visual overlays need be applied to the image on the user playback device 60. This means that the experience of others watching the broadcast programme 50 on the user playback device 60 can be entirely unaffected by another user who has chosen to interact with the programme via their own user device 20.

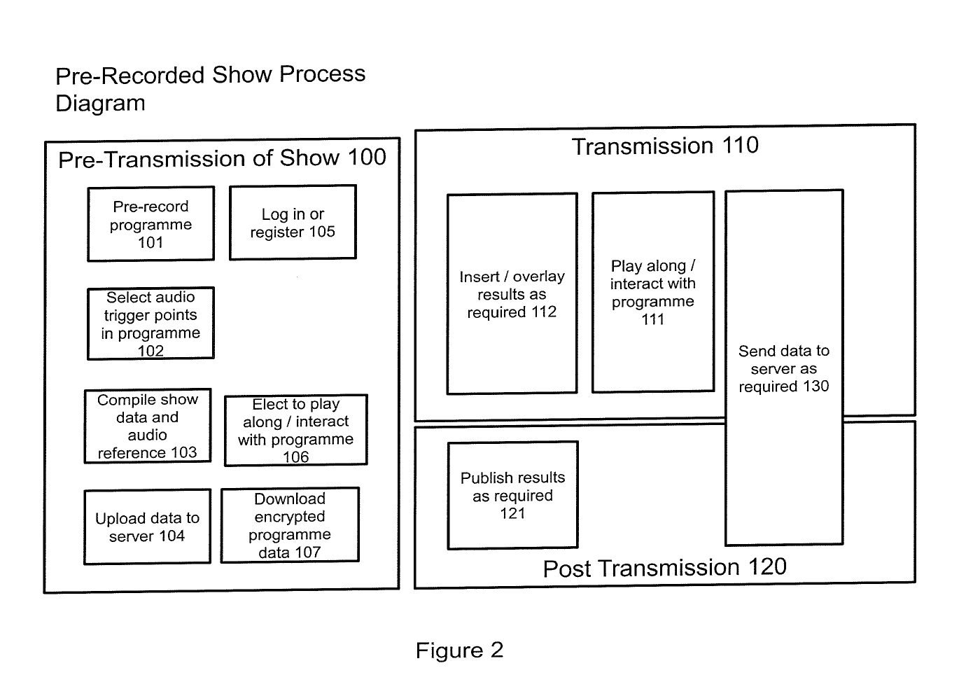

Referring briefly to FIG. 2, which shows schematically an example of the overall process concerning a show or other programme 50 that is pre-recorded, prior to transmission of the show 100, the programme 50 is pre-recorded 101. Being a pre-recorded programme 50, the triggers can be various audio trigger points already present in the programme 50 and these are selected 102. Alternatively, specific audio triggers may be inserted. Next, the show data and audio references, which are to be downloaded by the user device 20, are compiled 103 and then uploaded 104 to the server 10.

Also prior to transmission of the show 100, the user logs and/or registers 105 with the server 10 using the second user device 20. Subsequently, the user elects to play along or otherwise interact 106 with the broadcast programme 50. As a result, the encrypted programme data for the desired interaction is downloaded 107 for storage on or otherwise local to the second user device 20.

During transmission of the show 110, the user plays along with or otherwise interacts with the show 111 using the second user device 20. Results of the interaction are overlaid or otherwise inserted 112 on the display screen of the second user device 20. After transmission of the show has ended 120, the results for that user and, more generally, all relevant users (such as the “winners” of competitions, etc.) are published 121. Data from the second user devices 20 of the users is sent 130 to the server 10 as required. As noted above, in many embodiments, this takes place after transmission of the show has ended, but this data may nevertheless be sent at predetermined intervals during transmission of the show.

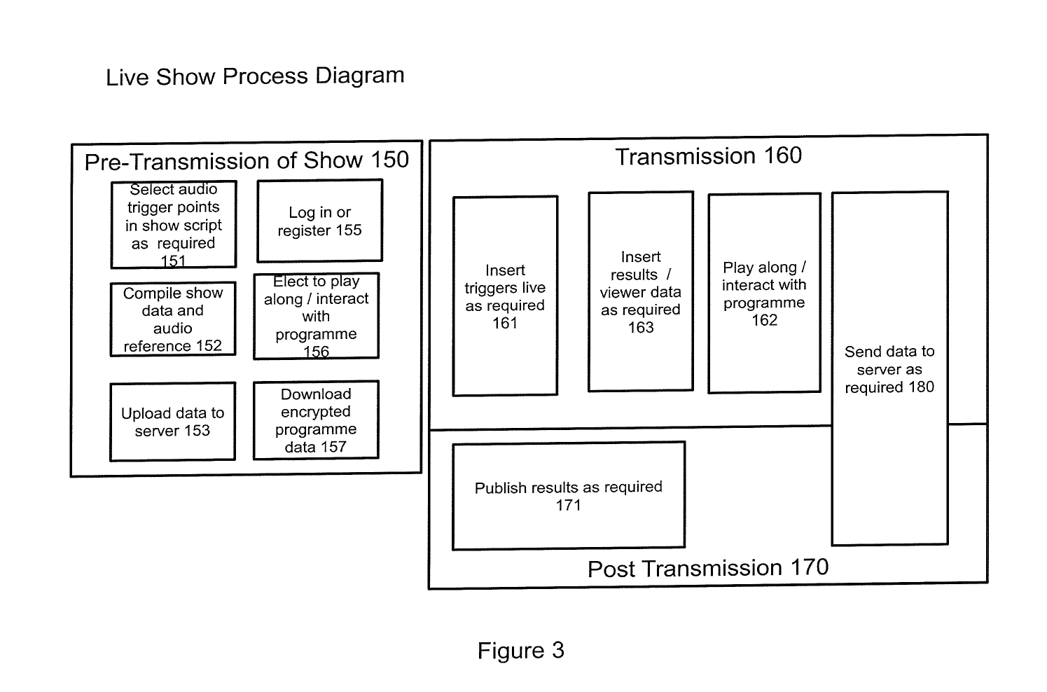

Referring briefly to now FIG. 3, which shows schematically an example of the overall process concerning a show or other programme that is broadcast live, prior to transmission of the show 150, certain audio trigger points, which it is known will appear in the show, are selected as required 151, these being script lines, music segments, etc. Next, the show data and audio references, which are to be downloaded by the user device 20, are compiled 152 and then uploaded 153 to the server 10.

Also prior to transmission of the show 150, the user logs and/or registers 155 with the server 10 using the second user device 20. Subsequently, the user elects to play along or otherwise interact 156 with the broadcast programme 50. As a result, the encrypted programme data for the desired interaction is downloaded 157 for storage on or otherwise local to the second user device 20.

During transmission of the show 160, as well as using the pre-existing audio points selected at 151 as mentioned above, specific triggers may be inserted live 161 into the show as it is broadcast. The user plays along with or otherwise interacts with the show 162 using the second user device 20. Results of the interaction are overlaid or otherwise inserted 163 on the display screen of the second user device 20. After transmission of the show has ended 170, the results for that user and, more generally, all relevant users (such as the “winners” of competitions, etc.) are published 171. Data from the second user devices 20 of the users is sent 180 to the server 10 as required. Again, as noted above, in many embodiments, this takes place after transmission of the show has ended, but this data may nevertheless be sent at predetermined intervals during transmission of the show.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of triggering an event, the event being associated with content being broadcast over a medium and being played back on a user playback device, the method comprising:
receiving, at a second user device, at least one of an audio component and a video component of content that is being played back on a user playback device;
comparing the received audio component and/or video component with comparison data that is stored on or otherwise locally accessible to the second user device; and
when the received audio component and/or video component contains an element that, in accordance with the comparison, is determined to correspond to an audio cue or a visual cue respectively that is transmitted with the content, causing an event to be triggered by the second user device.

2. The method according to claim 1, wherein the triggered event comprises the second user device outputting a prompt for the user.

3. The method according to claim 1, wherein the triggered event comprises starting a timer that is based on a clock associated with the second user device.

4. The method according to claim 1, wherein the triggered event comprises initiation of a procedure that permits user input to the second user device.

5. The method according to claim 4, further comprising transmitting the results of user input.

6. The method according to claim 1, wherein the triggered event comprises starting a timer that is based on a clock associated with the second user device, and outputting, a predetermined time after the timer has started, a prompt to the user indicating that user input is required, wherein the method further comprises:
receiving a user input at the second user device and recording the elapsed time from when the prompt was output to when the user input was received, and
transmitting data corresponding to the user input and the elapsed time.

7. The method according to claim 6, wherein said data corresponding to the user input and the elapsed time is transmitted to at least one of a provider of the content and a broadcaster of the content.

8. The method according to claim 1, further comprising prior to the content being transmitted, receiving comparison data for use in the comparison and storing said comparison data at or locally to the second user device.

9. A user device for triggering an event, the event being associated with content being broadcast over a medium and being played back on a user playback device, the user device comprising:
a receiver for receiving at least one of an audio component and a video component of content that is being played back on a user playback device; and
a processing system arranged to compare the received audio component and/or video component with comparison data that is stored on or otherwise locally accessible to the user device, and arranged to cause an event to be triggered when the received audio component and/or video component contains an element that, in accordance with the comparison, is determined to correspond to an audio cue or a visual cue respectively that is transmitted with the content.

10. The user device according to claim 9, wherein the processing system is arranged to cause an event to be triggered that comprises outputting a prompt for the user.

11. The user device according to claim 9, wherein the processing system is arranged to cause an event to be triggered that comprises starting a timer that is based on a clock associated with the user device.

12. The user device according to claim 9, wherein the processing system is arranged to cause an event to be triggered that comprises initiation of a procedure that permits user input to the user device.

13. The user device according to claim 12, wherein the processing system is arranged to cause transmission of the results of user input.

14. The user device according to claim 9, wherein the processing system is arranged to cause an event to be triggered that comprises starting a timer that is based on a clock associated with the user device, and outputting, a predetermined time after the timer has started, a prompt to the user indicating that user input is required, the user device having an input device arranged to receive a user input, the processing system being arranged to record the elapsed time from when the prompt was output to when the user input was received and to cause transmission of data corresponding to the user input and the elapsed time.

15. The user device according to claim 14, wherein the processing system is arranged to cause transmission of said data corresponding to the user input and the elapsed time to at least one of a provider of the content and a broadcaster of the content.

16. A method of triggering an event, the event being associated with content being broadcast over a medium and being played back on a user playback device, the method comprising:
transmitting comparison data and event data relating to content that is to be subsequently broadcast for play back on a user playback device, the comparison data and the event data being for storage at or locally to a second user device;
subsequently broadcasting said content for play back on a user playback device; and
receiving a result of a user input to a said second user device that is given in response to an event being triggered by the second user device that indicates that user input is required, the event being triggered at a said second user device by the event data following a comparison of at least one of an audio component and video component of the content being played back on a said user playback device and received at a said second user device with the comparison data that is stored on or otherwise locally accessible to a said second user device wherein the comparison is determined to correspond to an audio cue or a visual cue respectively that is transmitted with the content.

17. The method according to claim 16, wherein the event data is arranged to cause output of a prompt for a user by a said second user device.

18. The method according to claim 16, wherein the event data is arranged to cause starting of a timer that is based on a clock associated with a said second user device, and the receiving comprises receiving timing data that corresponds to the time taken from the event being triggered at a said second user device to the user input being received at a said second user device.

19. Apparatus for triggering an event, the event being associated with content being broadcast over a medium and being played back on a user playback device, the apparatus comprising:
a transmission system arranged to transmit comparison data and event data relating to content that is to be subsequently broadcast for play back on a user playback device, the comparison data and the event data being for storage at or locally to a second user device;
a broadcast system arranged to subsequently broadcast said content for play back on a user playback device; and
a receiver for receiving a result of a user input to a said second user device that is given in response to an event being triggered by the second user device that indicates that user input is required, the event being triggered at a said second user device by the event data following a comparison of at least one of an audio component and video component of the content being played back on a said user playback device and received at a said second user device with the comparison data that is stored on or otherwise locally accessible to a said second user device wherein the comparison is determined to correspond to an audio cue or a visual cue respectively that is transmitted with the content.

20. The apparatus according to claim 19, wherein the transmission system is arranged to transmit event data that is arranged to cause output of a prompt for a user by a said second user device.

21. The apparatus according to claim 19, wherein the transmission system is arranged to transmit event data that is arranged to cause starting of a timer that is based on a clock associated with a said second user device.

22. A non-transitory computer-readable storage medium comprising instructions stored thereon such that when the instructions are executed on a user device with a processor, the user device is arranged to:
receive at least one of an audio component and a video component of content that is being played back on a user playback device;
compare the received audio component and/or video component with comparison data that is stored on or otherwise locally accessible to the user device; and
when the received audio component and/or video component contains an element that, in accordance with the comparison, is determined to correspond to an audio cue or a visual cue respectively that is transmitted with the content, cause an event to be triggered by the second user device.
